(19) United States
(12) Patent Application Publication
(10) Pub. No.: US 2009/0095592 A1
(43) Pub. Date: Apr. 16, 2009

(54) Secondary clutch lever

(76) Inventors: Kerry David Simmons, Chesapeake, VA (US); Gustav Eugene Steese, II, Kitty Hawk, NC (US); Shawn Wayne Lambert, Chesapeake, VA (US)

Correspondence Address: GUERRY LEONARD GRUNE, 784 S VILLIER CT., VIRGINIA BEACH, VA, 23452, US

(21) Appl. No.: 11/974,842

(22) Filed: Oct. 15, 2007

(51) Int. Cl. B62M 25/04

(52) U.S. Cl. 192/99 S

(57) ABSTRACT

Disclosed is a secondary clutch lever device for any vehicle having a handlebar for steering and a primary clutch lever mounted the handlebar. The secondary clutch lever has an adjustment feature and is biased to return to a secondary neutral position allowing the primary clutch lever to return to a primary neutral position. An adjustment prevents the secondary clutch lever from returning to the secondary neutral position also preventing the primary clutch lever from returning to a primary neutral position thereby retaining tension on the clutch cable allowing a reduction in the coupling forces in a clutch assembly causing the clutch assembly to slip momentarily until rotational forces of the engine overcome the slippage fully engaging the clutch assembly thereby eliminating stalling during propulsion.

### FIELD OF DISCLOSURE

The present disclosure relates to an adjustable secondary clutch lever device for vehicles with hand activated clutch levers.

### BACKGROUND OF DISCLOSURE

Clutch assemblies are generally known in the transportation industries and are used to couple an engine to an input of a transmission for providing motion to a vehicle, such as an all-terrain vehicle (ATV) or motorcycle. A typical clutch system couples an engine crankshaft to an input shaft of the transmission by using numerous spring loaded friction discs, or plates. Some of the discs are mechanically coupled to the input shaft of the transmission, while other discs are coupled to the engine crankshaft via a gear mechanism. The transmission input shaft rotates in response to rotation of the engine crankshaft when the friction discs are compressed together. To decouple the input shaft of the transmission from the engine, the compression force, usually by spring or hydraulically actuated, is removed from the friction discs such that friction between adjacent discs is reduced causing the surfaces to “slip” on the adjacent disc surfaces. The clutch system may be dry or wet, depending on whether the discs are bathed in a friction modifying solution of absent of any fluids.

To remove or reduce the compressive forces on the clutch disks as a pack, a clutch release mechanism is provided. In a typical application, the release mechanism is activated using a primary clutch lever attached to the handlebars of the vehicle. The clutch lever is attached to the clutch disc mechanism using either a cable or a hydraulic line. Pulling the primary clutch lever toward the driver typically disengages the clutch discs whereas releasing the primary clutch lever, which is usually spring assisted, allowing the lever to move away from the driver engages the clutch discs. When the discs are engaged, power is transmitted from the engine through the discs to the transmission and to the driving wheel(s) or method of propelling the vehicle. A driving method may be one of more wheels or a track in a snowmobile or a prop or propulsion unit of a jet ski or other watercraft.

Motocross is a sport involving motorcycles or all-terrain vehicles (ATVs) racing held on off-road circuits. The name “motocross” is a contraction derived from the words “Motorcycle” and “Cross Country”. In a typical motorcycle motocross, competitors are aligned at a starting gate. While at the gate, drivers increase the revolutions per minute (rpm) of the motorcycle engines in anticipation of the gate falling away, releasing the primary clutch lever and fully engaging the engine and transmission at increased power through a set of clutch discs to rotate the rear tire thereby propelling the motorcycle in the fastest manner toward the race course. The objective of this starting method is to perform a “holeshot” wherein the holeshot defines the beating an opponent off the starting line and being ahead of the other competitors in an almost immediate fashion. Many factors can negatively limit the ability of a competitor to perform a holeshot.

In many instances, when the gate drops, the motorcycles not only propel forward, but the front wheel lifts off the ground thereby causing the driver to lose the ability to steer. A shift in body weight of the driver or an defect in the starting surface, such as a rut, may cause the motorcycle to veer left or right potentially impacting another motorcycle and crashing into one or more motorcycles. Additionally, the motorcycle may flip over. Serious injuries to competitors and damage to machinery are known results of losing the steering function.

Drivers may compensate for the wheel lift by leaning over the handlebars and applying their weight to the front of the motorcycle. Leaning over the handlebars reduces the ability to steer and places the driver in a likely position to overcompensate for leaning over the handlebars and be thrown forward, over the handlebars, resulting as well in serious injury and damage to one or more competitors.

Similar starting and compensating maneuvers are found in ATV racing. Most notably is where the ATV driver increases the revolutions of the engine and when the primary clutch lever is released and the clutch system is allowed to fully engage, the clutch, transmission and driving wheel(s) place such a load on the engine, that the engine's response is to decrease the revolutions, and thus the power generated available to drive the driving wheels is reduced causing a “stall” conditions. This “stall” condition causes the ATV to pitch forward, moving the driver from a safe seated position and then propels the ATV forward so that the driver is then moved rearward in a forceful manner. For young competitors, this motion may cause loss of control or the ATV and body position and possible injury.

What is needed is a clutch lever mechanism and safety device for motorcycles, ATVs and other hand clutched vehicles that allow for the drivers of such vehicles to increase the power output of their engines by increasing the rpms and minimizing “stall”, eliminating raising the front wheel(s) by expending a select level of energy through clutch disc engagement in a manner as to progressively engage the clutch discs enabling a smooth transition upon startup to gain a holeshot thereby allowing the driver to maximize the start velocity and remain in control of the motorcycle, ATV or other vehicle in the optimum safe driving position.

Relevant Art

U.S. Pat. No. 7,083,035, to Noguchi, et. al., assigned to Honda Motor Co., describes a clutch lever mechanism for a motorcycle. The lever bracket is attached to a handlebar and a clutch lever is attached to the lever bracket so that the clutch lever can be pivoted. One end of the clutch wire is connected to the clutch lever so that the clutch can be operated by the clutch lever. An adjusting bolt is screwed to the lever bracket and the quantity of the play of the clutch lever can be adjusted by turning the adjusting bolt comprising; a dial member made of elastic material and provided with a finger positioning part for positioning a finger on the peripheral face is set on the adjusting bolt so that the adjusting bolt can be turned via the dial member. The lever bracket is covered with a lever cover made of elastic material and arranged in series with the dial member along the clutch wire wherein concave portions are provided on a rear end face of the lever cover in a position opposite to an end face of the dial member and after the dial member is turned, a convex portion provided on the end face of the dial member can be fitted to an arbitrary one of the concave portions provided on the lever cover.

U.S. Pat. No. 5,247,852, to Guerr, Herbert, assigned to Applied Tectonics, Inc., describes an apparatus for coupling hand controls to a handlebar tube comprising; an engagement collar having a partially spherical outer surface and a central bore disposed therethrough mounted upon and adapted to frictionally engage the handlebar tube. A hand control housing has a front and rear and first and second side surfaces with the distance between the front and rear surfaces being less than the diameter of the outer spherical surface of the engagement collar. A sleeve is disposed through the housing from the front surface to the rear surface with the sleeve defining a spherical surface which is adapted to frictionally engage the partially spherical outer surface of the engagement collar. The hand control housing is coupled to the collar and the sleeve circumscribe the handlebar tube and a means for clamping the hand control housing and engagement collar to the handlebar tube with the coupled intermediate and the first and second side surfaces of the hand control housing.

U.S. Pat. No. 6,102,183, to Gerken, Roland J., assigned to Excelsior-Henderson Motorcycle Manufacturing Co., describes a motorcycle clutch release comprising; a housing having a cylinder formed, a piston sized to slidably fit within the cylinder; a pair of hydraulic seals attached to either the housing cylinder or the piston and an adjustable pull rod. The adjustable pull rod has a first end attached to the piston and a second end adapted to pull on a clutch pressure plate to disengage the clutch in response to movement of the piston. The adjustable pull rod passes through an opening in the piston and is coupled to the piston to allow for adjustment between the piston and the second end of the pull rod.

U.S. Pat. No. 4,149,432, to Costahaude, Mark A., unassigned, describes in a motorcycle, the combination of a handlebar having a handgrip on one of its extremities and a control lever, including a pivot support and an actuating handle extending in a generally linear direction from the pivot support. There is an operating arm whose length is short compared to the length of the actuating handle and which extends from the pivot support in a direction substantially perpendicular to the actuating handle. There is a means of mounting the pivot support of the lever upon the handlebar forwardly of the handgrip so that the actuating handle may be positioned at an angle of about 45 degrees relative to the handgrip or may instead be selectively pivoted generally parallel to the handgrip. A control line for the motorcycle brake or clutch is secured to the outer end of the operating arm of the lever so that a pivotal movement of the actuating handle, toward the handgrip imparts a pulling force upon the control line. The actuating handle is of such configuration that when pivoted inward towards the handgrip, an intermediate portion of its length engages the surface of the handgrip. The rearward extremity of the actuating handle is outwardly offset relative to the intermediate portion so that the two smallest fingers of the motorcycle rider may remain in engagement with the handgrip without being mashed by the actuating handle and the intermediate portion of the length of the actuating handle provides on the outer surface a downwardly curved hook which is of sufficient length to be conveniently grasped by both the middle finger and forefinger of the motorcycle rider. The motorcycle rider may either leave all four of his fingers in engagement with the handgrip or may extend his middle finger and forefinger above the hook portion of the actuating handle in order to operate the lever while keeping his two smallest fingers in engagement with the handgrip, or alternatively, when the lever has been partially operated by means of his middle finger and forefinger may then extend his two smallest fingers for gripping the outer surface of the offset rearward extremity of the actuating handle in order to completely draw the actuating handle toward the handgrip.

U.S. Pat. No. 6,263,754, to Wesling, et. al., assigned to SRAM Corp., describes an operating device comprising; a nonrotatable bracket for affixation to a handlebar and a hand lever pivotally attached to the mounting bracket about a pivot axis. The hand lever also rotates relative to the mounting bracket, about a rotation axis offset from, and not parallel to, the pivot axis. A transmission mechanism is coupled to the hand lever for translating a torque induced about the rotation axis by a first force applied to the hand lever into a second force drawing the hand lever about the pivot axis toward the handlebar.

U.S. Patent Publication No. 2007/0079664A1, to Hajek, Karel, unassigned, describes a clutch built using only 7075 aluminum which will make it super tough, and resistant to wear and tear. The clutch system will allow users to adjust free play while riding, without having to stop as it is currently done. It will provide its users with more flexibility and ease of use. It will provide a clear advantage over what is available in the market today.

U.S. Patent Publication No. 2007/0056827A1, to Wu, Shih-Hsiung, unassigned, describes a clutch device for a motorcycle comprising, a body comprising a side, at least two centrifugal weights pivotably mounted on the side of the body. Each of the at least two centrifugal weights comprising a clutch plate on an outer periphery face thereof and each of the at least two centrifugal weights further comprising a through-hole extending from an inner side thereof through the outer periphery face thereof. There is a spring-attaching member mounted in the through-hole of each of the at least two centrifugal weights and comprising a first end and a second end that has a screw hole, an adjusting screw being mounted in each spring-attaching member and at least two springs each comprising a first end attached to an associated one of the at least two centrifugal weights and a second end attached to the first end of the spring-attaching member on another one of the at least two centrifugal weights. Each spring-attaching member moves along a longitudinal direction of an associated one of the through-holes when an associated one of the adjusting screws is turned, thereby adjusting tightness of an associated one of the at least two springs.

U.S. Patent Publication No. 2006/0070483A1, to Dimsey, et. al., unassigned, describes a lever that pivots about an axis, a lever mounting structure from which the lever extends and a thumbwheel having a cam thereon and disposed directly between the lever and the lever mounting structure, wherein the thumbwheel rotates about an axis that is perpendicular to the axis of lever pivoting.

### SUMMARY OF THE DISCLOSURE

An embodiment of the disclosure is an adjustable secondary clutch lever device for a vehicle having a handlebar for steering and a primary clutch lever mounted the handlebar, with a clutch cable removeably attached to the primary clutch lever and a secondary clutch lever that has an adjustment feature and mounted in close proximity of the primary clutch lever wherein the secondary clutch lever is biased to return to a secondary neutral position allowing the primary clutch lever to return to a primary neutral position, and wherein an adjustment of the secondary clutch lever prevents the secondary clutch lever from returning to the secondary neutral position also preventing the primary clutch lever from returning to a primary neutral position thereby retaining tension on the clutch cable attached to a clutch assembly at an end allowing a reduction in the coupling forces in a clutch assembly allowing the clutch assembly to slip momentarily wherein rotational forces of an engine overcome the reduced compressive forces allowing for minimal slippage of the clutch assembly thereby causing the vehicle to smoothly fully engage the coupling forces to the method of propulsion thereby eliminating stalling during propulsion.

Another embodiment of the disclosure is an adjustable secondary clutch lever device that is attached to the handlebar, in proximity of the primary clutch lever and/or removably attached to a primary clutch lever of a hand clutched vehicle such as an ATV, motorcycle, snowmobile, jet ski, watercraft, mini-bike or other typical handlebar steered vehicle that may be selectively used by the driver wherein the secondary clutch lever device may be disengaged at any time.

Another embodiment of the disclosure is an adjustable secondary clutch lever device that is engaged or disengaged by either hand that activates the primary clutch lever.

Another embodiment of the disclosure is an adjustable secondary clutch lever device that adjustably preferably prevents a released primary clutch lever from returning to a fully released position allowing for 0% to 100% engagement of the clutch assembly.

Another embodiment of the disclosure is an adjustable secondary clutch lever device that is adjustable to provide a proper amount of clutch assembly disengagement to create slippage of the clutch discs thereby reducing power generated to the propulsion method or drive wheel(s) thereby compensating for engine horsepower, clutch response, driver weight, track surface conditions, traction between the drive wheel(s) and the race surface and preventing the engine from near stall or stalling conditions at startup under initial load.

Another embodiment of the disclosure is an adjustable secondary clutch lever device that may be disengaged once the vehicle is in motion allowing the primary clutch lever to return to the primary neutral position and full engagement of the clutch assembly thereby minimizing slippage loss and inefficiency and enabling peak performance of the vehicle.

Another embodiment of the disclosure is an adjustable secondary clutch lever device wherein the adjustment is a block, stop, threaded rod, pin, bolt, adjustment screw, spring, dowel, ferrule, slider, pawl, cam, solenoid or electromechanical means individually or in combination and is not adjustable without a tool.

### BRIEF DESCRIPTION OF THE DRAWINGS

FIG. 1 is a prior art isometric of a primary clutch lever in a typically mounted position on the handlebars of a motorcycle.

FIG. 2 is a top view of the primary clutch lever and an engaged adjustable secondary clutch lever showing the mounting of the secondary clutch lever, adjustment and the secondary clutch lever stop and a description of the operation.

FIG. 3 is a top view of the primary clutch lever and the clutch lever mechanism showing a fully engaged primary clutch lever and a disengaged adjustable secondary clutch lever.

FIG. 4 is a graph of the response curves, in engine RPM over time, of the disclosed adjustable secondary clutch lever to the prior art.

### DETAILED DESCRIPTION OF THE DRAWINGS

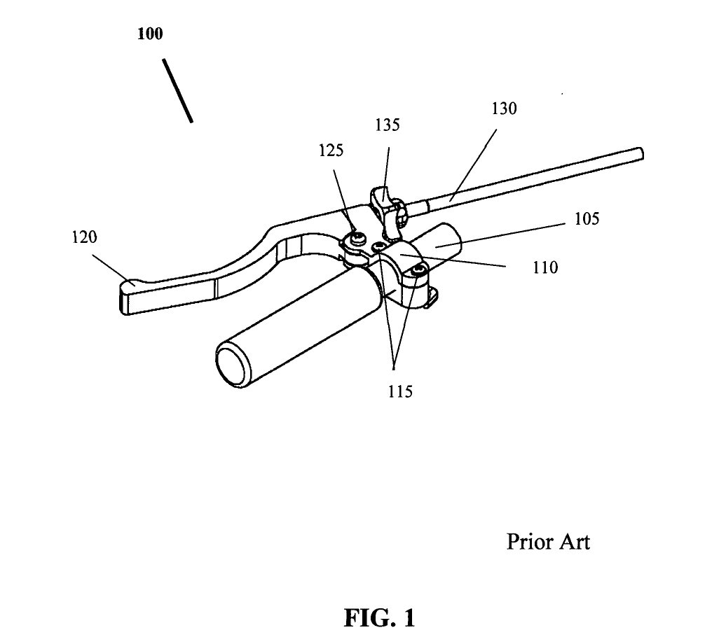

FIG. 1 shows the prior art of a primary clutch lever [100] in a typically mounted position on the handlebar [105] of a vehicle, such as a motorcycle or ATV (not shown). The mounting device is usually a clamp [110] style wherein the inside diameter of the clamp [110] is a slightly smaller diameter than that of the handlebar [105] outside diameter. The clamp is split and contains holes for assembling the clamp [110] to the handlebars [105] with one or more fastener [115] such as a bolt. Assembling the clamp [110] to the handlebar [105] is preferably placed near the end of the handlebar [105] for ease of operation. Also attached to the clamp [110] is the primary pulling lever [120]. The primary pulling lever [120] is typically attached by a pin [125] that penetrates the clamp [110] pulling lever [120] rotatably attaching the primary pulling lever [120] to the clamp [110]. The pin [125] allows the primary pulling lever [120] to rotate about the pin [125] in a manner to pull the primary clutch cable [130].

The cable [130] has a ferrule [135] that is loosely contained within a hole in the primary pulling lever [120] allowing the cable [130] to have relatively linear motion when the primary pulling lever [120] is moved toward the handlebar [105]. Not shown is the distal end of the cable [130] where it attaches to a typical clutch assembly wherein the cable typically has a spring force pulling the cable [130] toward the clutch assembly. The typical position for the cable [130] and primary pulling lever [120] is where the primary pulling lever [120] is furthest away from the centerline of the handlebar [105] as allowed by the clamp [110]. In this position the clutch assembly discs (not shown) are in full contact with each other. Operation of this type of clutch system is well understood by those skilled in the art.

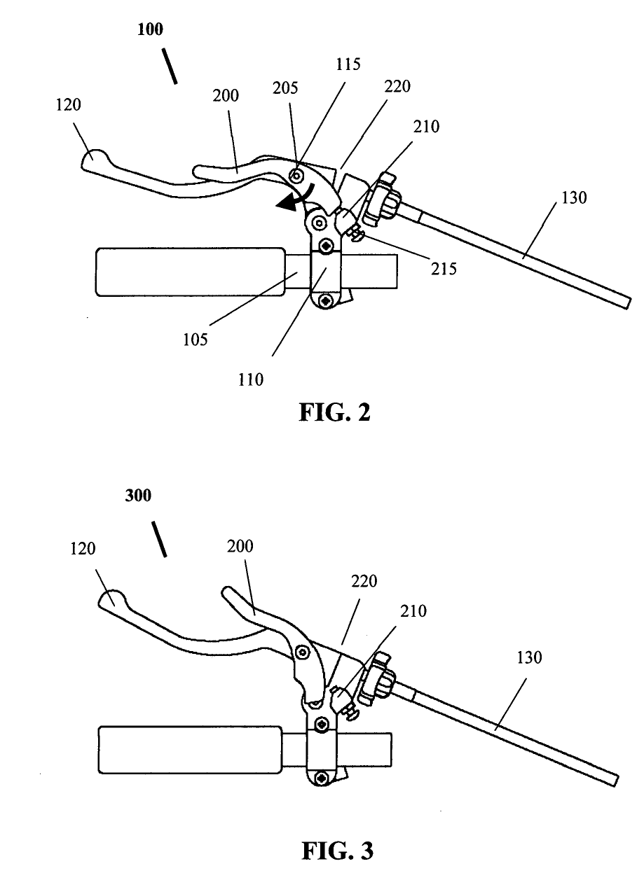

FIG. 2 is a top view of the primary clutch lever [100] and the adjustable secondary clutch lever [200] showing the mounting of the secondary clutch lever [200] to the primary clutch lever [100] mounted by a clamp [110] to the handlebar [105]. The secondary clutch lever [200] is mounted to the primary clutch lever [100], more specifically on the primary pulling lever [120], by a fastener [115]. Disclosed is a fastener with a wrap spring [205] around its diameter, that causes the secondary clutch lever [200] to rotate away (shown as clockwise movement and illustrated in FIG. 3) from the adjustment stop [210]. When the adjustable secondary clutch lever [200] is in contact with the adjustment stop [210] there is a gap [220] between the primary pulling lever [120], which is now partially engaged, and the clamp [110]. Additional mounting and movement means will be apparent to those skilled in the art.

The adjustment stop [210] contains an adjuster [215] such as a threaded rod, block, stop, pin, bolt, adjustment screw, spring, dowel, ferrule, slider, pawl, cam, solenoid or electromechanical device. Adjustment to the position of the secondary clutch lever [200] at the adjustment stop [210] may be performed with the vehicle's engine running or by measurement, such as a gap or distance. It is anticipated that final adjustments will be made with the engine running to be able to note where engine revolutions decrease when the primary clutch lever [100] with an adjusted and engaged secondary clutch lever [200] are released.

Operationally, with the vehicle engine running, the secondary clutch lever [200] and the primary clutch lever [100] are grasped within the fingers of the driver at the same time and pulled toward the handlebar [105]. This is usually performed while the transmission is in neutral, or unengaged, allowing no rotational force to flow through the transmission. With the primary clutch lever [100] and the secondary clutch lever [200] pulled toward the handlebar [105], the cable [135] is pulled disengaging the clutch assembly, overriding the spring force in the clutch assembly and allowing the clutch discs to move apart. The driver then places the transmission in the preferred gear with the clutch still disengaged and provides fuel to increase the revolutions of the engine. When the engine has reached the preferred revolutions, both the primary clutch lever [100] and the secondary clutch lever [200] are released simultaneously. The simultaneous release of the primary clutch lever [100] and the secondary clutch lever [200] allow the spring force of the clutch assembly to pull the cable [135] toward the clutch assembly in an attempt to allow the clutch discs come in full contact with each other. The secondary clutch lever [200] however restricts the full engagement of the clutch discs on initial release thereby allowing the clutch discs that are directly attached to the engine side of the clutch assembly to slip slightly on initial contact with the stationary clutch discs on the transmission side of the clutch assembly. As the engine side clutch discs rotate, the centrifugal force created by the rotating engine side discs engage the transmission side discs fully, thereby fully engaging the clutch assembly for the maximum power transmitted to the driven wheel(s) or method of propulsion.

An embodiment of this disclosure is that the adjustment of the secondary clutch lever [200] provides a preferred amount of slippage of the clutch assembly to eliminate engine stalling when the primary clutch lever [100] is released.

FIG. 3 is a top view of the adjustable secondary clutch lever [200] showing a fully engaged [300] primary pulling lever [120] with the adjustable secondary clutch lever [200] disengaged. Note that gap [220] no longer exists with the adjustable secondary clutch lever [200] not contacting the adjustment stop [210]

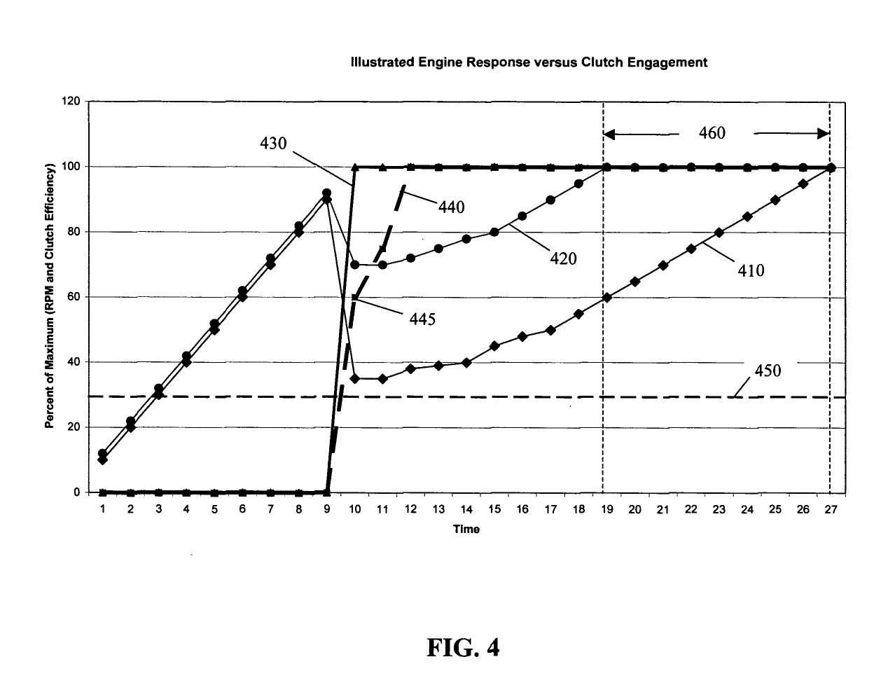

FIG. 4 is a comparative graph of the response curves, in engine RPM over time, of the disclosed adjustable clutch lever versus the prior art. The engine revolutions per minute (RPM) shown as prior art RPM [410] and disclosed RPM [420] are increased to about 90 percent of RPM and clutch efficiency. Shown as time (point 9), the clutch lever is released to engage the clutch assembly dropping the engine RPM [410] and [420]. In the case of the prior art RPM [410] when the primary clutch lever is released (between time point 9 and 10) the prior art RPM [410] decreases to near a stall line [450] and then increases to 100 percent RPM and clutch efficiency shown as time (point 27).

With the disclosed adjustable secondary clutch lever engaged, the primary clutch lever and the adjustable secondary clutch lever are released together allowing the clutch to slip momentarily [445] engaging the clutch assembly at 100 percent slower (time point 12) than the prior art, enabling the disclosed RPM [420] to remain higher than the prior art RPM [410] and thereby recovering to to 100 percent RPM and clutch efficiency sooner and shown as time (point 19). Maximum percent RPM and clutch efficiency is obtained sooner (time point 19 versus time point 27) than the prior art [460] thereby increasing performance.

Theory of Operation

With the adjustable secondary clutch lever mounted in proximity of the primary clutch lever and on a handlebar, the secondary clutch lever is adjusted so the secondary clutch lever is not in the secondary neutral position as it would be if the secondary clutch lever were disengaged. The adjustment of the secondary clutch lever against the adjustment mechanism also prevents the primary clutch lever (the one that comes with the vehicle) from returning to a primary neutral position. In this “off neutral” position, the clutch cable that attached to the primary clutch lever is tensioned, pulling the clutch cable towards the handlebars and slightly releasing the clutch mechanism.

Upon start up of the vehicle, the primary clutch lever and the secondary clutch lever are pulled toward the handlebars with the same hand thereby uncoupling the clutch assembly from the drive train and engine. More fuel is fed to the engine while it is uncoupled from the drive train allowing the engine revolutions to increase to a preferred amount. In a racing event the engine revolutions increase substantially versus an idle condition. With the engine revolutions high, the driver of the vehicle waits for the start of the event. At start, both the primary clutch lever and the secondary clutch lever in the adjusted position are released. A spring mechanism attempts to urge them to the primary and secondary neutral position, but the secondary clutch lever against the stop prevents this from occurring. The slight tension on the clutch cable from the primary clutch lever in non-neutral position allows the clutch mechanism to slip slightly causing a slight loss of power to the drivetrain and a lower load on the engine. This slip occurs for a moment, until the rotational (centrifugal) forces of the engine force the clutch assembly (discs) together as if the primary clutch lever were in neutral position. This slippage prevents stalling of the engine when the load of the drivetrain is applied.

Once started, the driver of the vehicle may shift to the next gear by grasping only the primary clutch lever and pulling it toward the handlebar. The movement of the primary clutch lever, released the secondary clutch lever off the stop, thereby allowing both clutch levers to attain neutral position when the primary clutch lever is released after shifting and operate without influence of the secondary clutch lever.

What is claimed is:

1. An adjustable secondary clutch lever device for a vehicle comprising; a handlebar for steering and a primary clutch lever mounted to said handlebar, with a clutch cable removeably attached to said primary clutch lever, and
a secondary clutch lever that has an adjustment feature and mounted in close proximity of said primary clutch lever wherein said secondary clutch lever is biased to return to a secondary neutral position allowing said primary clutch lever to return to a primary neutral position, and
wherein said adjustment feature of said secondary clutch lever prevents said secondary clutch lever from returning to said secondary neutral position also preventing said primary clutch lever from returning to said primary neutral position thereby retaining tension on said clutch cable allowing a reduction in the coupling forces in a clutch assembly attached to an end of said clutch cable, allowing said clutch assembly to slip momentarily wherein rotational forces of an engine overcome said reduced coupling forces allowing for minimal slippage of the clutch assembly thereby causing the vehicle to smoothly fully engage said coupling forces to a method of propulsion thereby eliminating stalling during said propulsion.

2. The adjustable secondary clutch lever device for a vehicle of claim 1, wherein said secondary clutch lever device attached to said handlebar, in said close proximity of said primary clutch lever of a hand clutched vehicle such as an ATV, motorcycle, snowmobile, jet ski, watercraft, mini-bike or other said handlebar steered vehicle wherein said secondary clutch lever device may be optionally used by a driver of said vehicle wherein said secondary clutch lever device may be disengaged at any time.

3. The adjustable secondary clutch lever device for a vehicle of claim 1, wherein said secondary clutch lever device adjustably and selectively prevents said primary clutch lever from returning to said primary neutral position allowing for 0% to 100% engagement of said clutch assembly.

4. The adjustable secondary clutch lever device for a vehicle of claim 1, wherein said secondary clutch lever device adjustment provides a proper amount of said clutch assembly disengagement to create said slippage of said clutch assembly thereby reducing power generated to said propelling method thereby compensating for engine horsepower, said clutch assembly response, driver weight, track surface conditions, traction between said propelling method and the transport surface and preventing the engine from said stalling conditions at startup under initial load.

5. The adjustable secondary clutch lever device for a vehicle of claim 1, wherein said secondary clutch lever device may be disengaged once said vehicle is in motion allowing said primary clutch lever to return to said primary neutral position having full engagement of said clutch assembly thereby minimizing slippage loss and inefficiency and enabling peak performance of said vehicle.

6. The adjustable secondary clutch lever device for a vehicle of claim 1, wherein said secondary clutch lever device wherein said adjustment feature is a block, stop, threaded rod, pin, bolt, adjustment screw, spring, dowel, ferrule, slider, pawl, cam, solenoid or electromechanical means individually or in combination and is not adjustable without a tool.
